(19) United States
(12) Patent Application Publication
(10) Pub. No.: US 2009/0297084 A1
(43) Pub. Date: Dec. 3, 2009

(54) Preset wheel bearing arrangement

(76) Inventor: James F. Ziech, Kalamazoo, MI (US)

Correspondence Address: MARSHALL & MELHORN, LLC, FOUR SEAGATE, 8TH FLOOR, TOLEDO, OH, 43804, US

(21) Appl. No.: 12/288,700

(22) Filed: Oct. 22, 2008

Related U.S. Application Data
(63) Continuation-in-part of application No. 12/156,078, filed on May 29, 2008.

(51) Int. Cl. F16C 19/52; B05B 17/04

(52) U.S. Cl. 384/551; 239/1

(57) ABSTRACT

A wheel bearing arrangement has a spindle having inboard and outboard portions, where the outboard portion cooperates with a fluid driven motor and a land connects the outboard portion and the inboard portion. The wheel bearing arrangement further has inboard and outboard bearing systems located radially outb from the land. Each bearing system has a bearing located between inner and outer races, where the inner race contacts the spindle land and the outer race contacts a wheel hub. In addition, a spacer is located between the two bearing systems, where the spacer extends from the land to a radially inwardly extending hub portion and where the spacer sets the preload on both bearing systems and diffuses inboard traveling fluid pressure spikes. A spindle nut is located outboard from the outboard bearing system to secure the bearing systems on the spindle.

### RELATED APPLICATION

This is a Continuation-In-Part application of U.S. Non-provisional application Ser. No. 12/156,078 with a filing date of May 29, 2008, which application is incorporated herein in its entirety.

### FIELD OF THE INVENTION

The present invention relates to a wheel bearing arrangement for a fluid driven motor. More particularly, the present invention relates to a preset wheel bearing spacer arrangement for a fluid driven motor.

### BACKGROUND OF THE INVENTION

Those skilled in the art know that some vehicles, such as trucks, farm vehicles, and heavy duty construction vehicles, have wheels that are driven by hydraulic drive motors located at each wheel end. In addition to the hydraulic motor, a hydraulically assisted wheel end may comprise a wheel brake drum, a steerable knuckle, hub, wheel, and tire assembly that is rotatably mounted radially outboard to the knuckle.

The hub is drivingly connected to the motor so that when the motor is energized, the hub drivingly rotates about the centerline of the knuckle, via bearings which are located between the knuckle and the hub. A kingpin pivotably connects an end portion of an axle of a vehicle to the knuckle, which permits the vehicle to be steered about the centerline of the kingpin. The knuckle also has an outboard portion that defines a spindle. The knuckle outboard portion is adapted to cooperate with the fluid driven motor. In addition, pressure supply ports communicate fluid to the motor, via pressure supply lines that cause the motor to drivingly rotate, thus causing the wheel to move forward and backward.

Typically, installations of heavy duty steer axle wheel bearings use a spindle nut to set the wheel bearing preload which is subject to operator error. Alternate unitized wheel bearing systems are generally assembly error proof but require expensive unitized bearings. Some conventional wheel end products use a large spacer and widely spaced wheel bearings to preset the bearing preload. However, a more compact system is needed that uses standard bearings and is still assembly error proof.

One relevant art system is embodied by U.S. Pat. No. 6,099,273 which depicts bearings separated by one another with an unnumbered and not discussed structure therebetween. This structure may be a seal or gasket. Of course, since this structure is not discussed in this patent, its effect on bearing preload is not discussed either.

Another relevant art system is embodied in U.S. Pat. No. 5,048,859 which teaches a threaded ring to adjust the preload on an inner race as well as to secure the position of the inner race. This reference, however, is silent on any structure disclosed therein as being a barrier to hydraulic pressure between the bearings.

What is sought is an effective, low cost structure to preset the bearing preload in a hydraulic motor equipped wheel end assembly. Such a structure would not rely on a spindle nut to set the bearing preload, which is prone to assembly error. In addition, this structure should be compact so as to cooperate with a short length spindle. Further, this structure should limit hydraulic pressure spikes to the hub fluid seal. It would be desirable for such an arrangement to be less expensive to produce, easier to package, and more robust than current methods.

### SUMMARY OF THE INVENTION

A wheel bearing arrangement has a spindle that comprises an inboard portion and an outboard portion, where the outboard portion cooperates with a fluid driven motor, and a land connects the outboard portion and the inboard portion. The wheel bearing arrangement further has an inboard bearing system and an outboard bearing system where both systems are located radially outward from the land. Each of the bearing systems comprises a bearing located between an inner race and an outer race, where the inner race contacts the spindle land and the outer race contacts a wheel hub. In addition, a spacer sets the preload on both of the bearing systems, where the spacer is located between the two bearing systems and extends from the spindle land to a radially inwardly directed finger or shoulder of the wheel hub. Thereby, the spacer diffuses inboard traveling fluid pressure spikes. A spindle nut is located outboard from the outboard bearing system to hold the bearing systems on the spindle.

Further advantages of the present invention will be apparent from the following description and appended claims, reference being made to the accompanying drawings forming a part of a specification, wherein like reference characters designate corresponding parts of several views.

### BRIEF DESCRIPTION OF THE DRAWINGS

FIG. 1 is a partial cross-sectional view of a vehicle hydraulic assist wheel end in accordance with the present invention;

FIG. 2 is a three dimensional view of a first embodiment of a spacer in accordance with the vehicle hydraulic assist wheel end of FIG. 1; and

FIG. 3 is a three dimensional view of a second embodiment of a spacer in accordance with the vehicle hydraulic assist wheel end of FIG. 1.

### DETAILED DESCRIPTION OF THE INVENTION

It is to be understood that the present invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions, directions, or other physical characteristics relating to the embodiments disclosed are not to be considered as limiting, unless the claims expressly state otherwise.

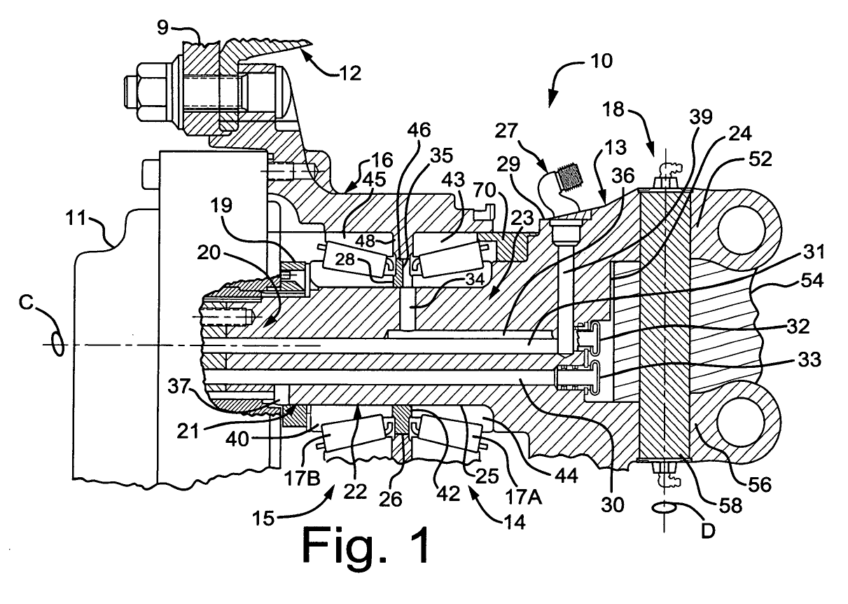

Illustrated in FIG. 1 is a preset wheel bearing arrangement 10 that comprises a wheel 9, fluid driven motor 11, wheel brake drum 12, steerable knuckle 13, and a wheel hub 16. The hub 16 is rotatably mounted radially outboard to the knuckle 13. The hub 16 is drivingly connected to the motor 11 so that when the motor 11 is energized, it causes the hub 16 to rotate. The motor 11 may be those produced by Poclain Hydraulics Industrie of France.

The hub 16 and the drum 12 rotate about the centerline C of the knuckle 13 by way of bearings 17A, 17B which may be standard and are located between the knuckle 13 and the hub 16.

The knuckle 13 has a spindle 22 that is defined by an outboard portion 21 and an inboard portion 23. The outboard portion 21 is adapted to cooperate with the fluid driven motor 11. Preferably, the motor 11 has a circular recess 20 for receiving the outboard portion 21 of the cylindrical spindle 22. A land 25 connects the outboard portion 21 and the inboard portion 23. A spindle nut 19 is located outboard from the bearings 17A, 17B to hold the bearings 17A, 17B on the spindle 22.

A first fluid pressure supply port 27 is located on an upper surface 29 of the knuckle inboard portion 18 for communicating fluid to the motor 11. Fluid flowing through the pressure supply port 27, via pressure supply line 39 that is connected to pressure supply line 31, rotates the motor 11 in a first direction, thus causing the hub 16 to move, for example, in a forward direction. Although not shown, another fluid pressure supply port is located elsewhere on a surface of the knuckle inboard portion 18 for also communicating fluid to the motor 11. Fluid flowing through the second fluid pressure supply port, via a second pressure supply line (not shown but also common in the art), rotates the motor 11 in a second direction, thus causing the hub 16 to move, for example, in a rearward direction.

Two fluid return drain lines 30, 36 are oriented substantially parallel one another near the centerline C of the knuckle 13 for draining fluid from the motor 11. The lines 30, 36 extend from the outboard portion 21 to ports 33, 32 located in the connecting wall 24 of the knuckle 13. Line 30 is shown draining hydraulic fluid from the motor 11 and a portion of the knuckle 13, while line 36 is shown draining hydraulic fluid from another portion of the knuckle 13. Although not shown in the particular cut away of FIG. 1, line 36 is also in fluid communication with the motor 11 itself. The lines 30, 36 may be connected to a sump system (not shown).

A first internal drain port 34 is preferably located between the inboard bearing 17A and the outboard bearing 17B. The internal drain port 34 is substantially oriented perpendicularly to the return drain line 36. The internal drain port 34 can be utilized to drain fluid to the return drain line 36.

Another internal drain port 37 is located outboard of the outboard bearing 17B. The internal drain port 37 is substantially oriented perpendicularly to the return drain line 30. The internal drain port 37 can be utilized to drain fluid to the return drain line 30.

The inboard portion of the knuckle 13 defines an upper boss 52 and a lower boss 56. A kingpin 58, which is located between the upper boss 52 and the lower boss 56, pivotably connects an end portion of an axle 54 of a vehicle (not shown) to the knuckle inboard portion. The kingpin 58 also permits the vehicle to be steered about a centerline D of the kingpin 58, wherein steering arms and tie rod arms (not shown) are typically disposed in the continuous channels of the bosses 52, 56. See, for example, U.S. patent application Ser. No. 12/283,559 with a filing date of Sep. 12, 2008, which application is incorporated herein in its entirety.

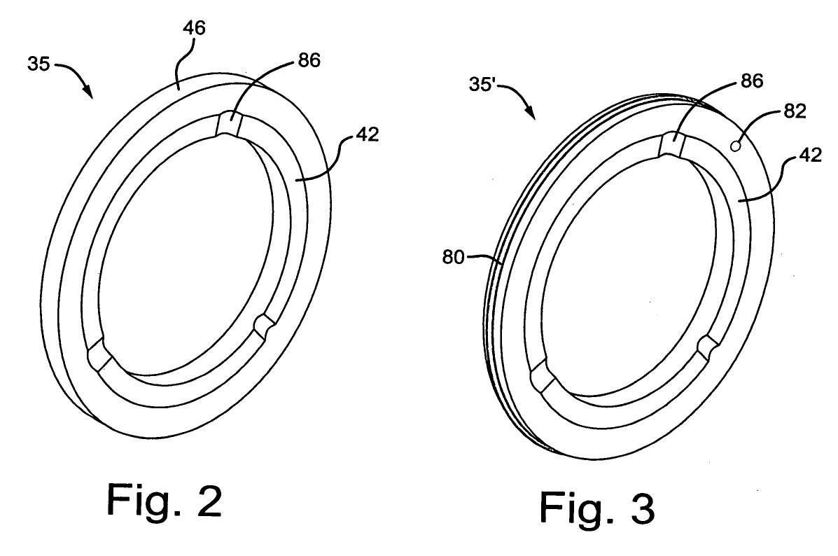

FIG. 1 also illustrates a compact spacer 35 located radially outward from the spindle 22 of the knuckle 13. The spacer 35 preferably has an outboard surface 28 in contact with an inner race 40 of the outboard bearing 17B. As shown in FIG. 2, the spacer 35 has a close fitting inboard surface 42 with one or more drain slots 86 (see FIGS. 2 and 3) that are in contact with an inner race 44 of the inboard bearing 17A, which also has an outer race 43. A radially outermost peripheral surface 46 of the spacer 35 has a small annulus clearance 26 that is in close proximity (for example, 0.2-0.3 mm or 0.008-0.012 inches) with an inwardly extending hub portion 48.

The bearings 17A, 17B rotatingly support the hub 16 about the knuckle 13. The inboard bearing 17A, the inner race 44, and the outer race 43 form an inboard bearing system 14. The outboard bearing 17B, the inner race 40, and an outer race 45 form an outboard bearing system 15.

Hence, the bearings 17A, 17B, which may be similar or physically the same part, are closely spaced and considered a double tapered bearing set. The selective spacer 35, which is located between the inner races of the bearings 17A, 17B, blocks fluid pressure spikes (for example, oil pressure spikes) in the spindle 22, from reaching a hub fluid seal 70, while still allowing a small metered amount of fluid to lubricate the inboard bearing 17A.

Such pressure spikes can cause erratic operation of the wheel and can cause early failures within the preset wheel bearing arrangement 10 which, for example, may cause early failure of the hub fluid seal 70. The spacer 35 functions to limit, by way of the small annulus clearance 26, fluid pressure spikes from reaching the hub fluid seal 70. Yet, the small annulus clearance 26 and/or the spacer drain slots 86 allow the fluid to drain through the drain port/line 34/36 and then to the exterior to the spindle 22.

FIG. 3 illustrates an alternate embodiment spacer 35′. Here, the small annulus clearance 26 of spacer 35 is replaced with a seal 80, such as an O-ring that is disposed on the surface 46, in a groove, to positively seal off fluid, for example oil, against the hub inner surface 46 and then an added small orifice hole 82 through the spacer and, possibly in conjunction with the slots 86, provide fluid leak pathways that are utilized to block fluid pressure spikes in the wheel end from reaching the hub fluid seal 70. Consequently, the spacer 35′ allows a small metered amount of fluid to lubricate the inboard bearing 17A via the small orifice hole 82 and/or slots 86.

Therefore, it has been discovered that a single part, the spacer 35, 35′, not only functions as a bearing spacer, but also functions as a fluid pressure spike diffuser. It has further been discovered that in disposing the spacer 35, 35′ between the bearing cones 17A, 17B, the thickness of the spacer determines the preload (or end play) of the bearings, regardless of how much torque is applied to the spindle nut 19. This is different from conventional heavy duty wheel ends, where the amount of torque on a spindle nut (and/or the advancement of nut rotations) will determine the bearing preload setting.

Hence, the invention provides a system, wherein a spacer 35, 35′ is selected from a set of spacers in order to provide the necessary dimensional bearing spacing needed for that application. Subsequently, a spindle nut torque can be used to securely clamp the bearing systems 14, 15 together. Conventionally, a bearing spacer does not fill up the space between the bearing cones to block fluid flow, as described in detail above. Here, the spacers 35, 35′ work with the fluid leak pathways 46, 82, 86 to drain the area between the bearings 17A, 17B, down through the drain port 34, and then the fluid drains down through the center of the spindle 22 by way of drain line 36.

Spacers 35, 35′ of various sizes may be used, which at least permits the use of the same spindle 12 and motor 11 while adapting to wheel assemblies of varying sizes. Preferably, the spacers 35, 35′ are of a unitary, one piece construction.

To summarize, the hydraulic motor wheel end 10 requires a separate close clearance 26 or alternatively the orifice 82, which controllably limits fluid pressure spikes to the inboard wheel bearing 17A, thereby preventing the hub seal 70 from being exposed to high fluid pressure that could destroy or limit the effectiveness of the hub seal 70. At the same time, a small metered amount of the fluid is provided to lubricate the inboard bearing 17A. Then, the spindle nut 19 is used to secure the wheel bearings 17A, 17B but not to set the bearing preload.

It can be appreciated that at least two preset wheel bearing arrangements 10, as discussed in detail above, could be utilized in a vehicle.

It is to be understood that the patent drawings are not intended to define precise proportions of the elements of the invention but that the patent drawings are intended to be utilized in conjunction with the rest of the specification. Unless expressly specified to the contrary, it should also be understood that the illustrated differences between various elements of the invention, which may be in fractions of a unit of measurement, are not intended to be utilized to precisely measure those differences between the various elements.

In accordance with the provisions of the patent statutes, the principles and modes of operation of this invention have been described and illustrated in its preferred embodiments. However, it must be understood that the invention may be practiced otherwise than specifically explained and illustrated without departing from its spirit or scope.

What is claimed is:

1. A wheel bearing arrangement, comprising:
a knuckle comprising a spindle, an inboard bearing, and an outboard bearing, the spindle cooperating with a fluid driven motor;
a spacer disposed between the spindle and a wheel hub, the spacer having a leak pathway for fluid to lubricate the inboard bearing, the leak pathway blocking fluid pressure spikes from reaching a hub fluid seal.

2. The wheel bearing arrangement of claim 1, wherein the spacer thickness determines the preloading of the bearings, regardless of the amount of torque applied to a spindle nut.

3. The wheel bearing arrangement of claim 1, wherein the fluid leak pathway comprises a radially outermost peripheral annulus surface of the spacer, between an inwardly extending hub portion, and/or a slot so as to allow a small metered amount of the fluid to lubricate the inboard bearing.

4. The wheel bearing arrangement of claim 1, wherein the fluid leak pathway comprises a clearance of 0.2-0.3 mm between a radially outermost peripheral annulus surface of the spacer and an inwardly extending hub portion, and/or an orifice through the spacer so as to allow a small metered amount of the fluid to lubricate the inboard bearing.

5. The wheel bearing arrangement of claim 1, wherein the fluid leak pathway comprises an orifice through the spacer and/or a slot on the spacer so as to allow a small metered amount of the fluid to lubricate the inboard bearing.

6. The wheel bearing arrangement of claim 5, wherein a radially outermost peripheral surface of the spacer has a seal disposed thereon.

7. The wheel bearing arrangement of claim 1, wherein the spacer is of unitary, one piece construction.

8. A wheel bearing arrangement, comprising:
a spindle comprising an inboard portion and an outboard portion, wherein the outboard portion cooperates with a fluid driven motor, and a land connects the outboard portion and the inboard portion;
an inboard bearing system and an outboard bearing system both located radially outward from the spindle, the bearing systems each comprising a bearing located between an inner race and an outer race, wherein the inner races contact the spindle land and the outer races contact a wheel hub; and
a spacer located between the two bearing systems, the spacer extending from the spindle land to a radially inwardly extending hub portion of the wheel hub and the spacer having at least one fluid leak pathway, wherein the spacer sets the preload on both bearing systems, regardless of the amount of torque applied to a spindle nut, and diffuses inboard traveling fluid pressure spikes from reaching a hub fluid seal;
wherein the spindle nut is located outboard from the outboard bearing system to hold the bearing systems on the spindle.

9. The wheel bearing arrangement of claim 8, wherein the fluid leak pathway comprises a clearance of 0.2-0.3 mm between a radially outermost peripheral annulus surface of the spacer and an inwardly extending hub portion, and/or a slot so as to allow a small metered amount of the fluid to lubricate the inboard bearing.

10. The wheel bearing arrangement of claim 8, wherein the fluid leak pathway comprises a clearance of 0.2-0.3 mm between a radially outermost peripheral annulus surface of the spacer and an inwardly extending hub portion, and/or an orifice through the spacer so as to allow a small metered amount of the fluid to lubricate the inboard bearing.

11. The wheel bearing arrangement of claim 8, wherein the fluid leak pathway comprises an orifice through the spacer and/or a slot on the spacer so as to allow a small metered amount of the fluid to lubricate the inboard bearing.

12. The wheel bearing arrangement of claim 8, wherein a radially outermost peripheral surface of the spacer has a seal disposed thereon.

13. The wheel bearing arrangement of claim 8, wherein the spacer is of unitary, one piece construction.

14. A method of diffusing a fluid pressure spike about a wheel bearing knuckle, comprising:
providing a spacer with a predetermined thickness based on a pre-determined bearing preload for a knuckle, regardless of the amount of torque applied to a spindle nut;
communicating fluid through a fluid pressure line in a knuckle and onto a fluid driven motor; and
diffusing a fluid pressure spike in fluid returning from the motor by way of the spacer disposed between a spindle of the knuckle and a wheel hub.

15. The method of diffusing a fluid pressure spike in a wheel bearing knuckle of claim 14, further comprising providing a leak pathway by way of a radially outermost peripheral annulus surface of the spacer between an inwardly extending hub portion and/or by way of a slot on the spacer, thereby allowing a small metered amount of the fluid to lubricate an inboard bearing.

16. The method of diffusing a fluid pressure spike in a wheel bearing knuckle of claim 14, further comprising providing a leak pathway by way of an orifice through the spacer and/or by way of a slot on the spacer, thereby allowing a small metered amount of the fluid to lubricate an inboard bearing.

17. The method of diffusing a fluid pressure spike in a wheel bearing knuckle of claim 14, further comprising a fluid leak pathway by way of an orifice through the spacer and/or a slot on the spacer, thereby allowing a small metered amount of the fluid to lubricate the inboard bearing.

18. The method of diffusing a fluid pressure spike in a wheel bearing knuckle of claim 14, wherein the bearings are physically the same part.

19. The method of diffusing a fluid pressure spike in a wheel bearing knuckle of claim 14, wherein a radially outermost peripheral surface of the spacer has an O-ring disposed thereon.

20. The method of diffusing a fluid pressure spike in a wheel bearing knuckle of claim 14, wherein the spacer is of unitary, one piece construction.
